(19) United States
(12) Patent Application Publication
(10) Pub. No.: US 2017/0193538 A1
(43) Pub. Date: Jul. 6, 2017

(54) SYSTEM AND METHOD FOR DETERMINING THE PRIORITY OF MIXED-TYPE ATTRIBUTES FOR CUSTOMER SEGMENTATION

(71) Applicant: ORACLE INTERNATIONAL CORPORATION, Redwood Shores, CA (US)

(72) Inventor: Mohammad HAJIAN, Malden, MA (US)

(21) Appl. No.: 14/989,049

(22) Filed: Jan. 6, 2016

(51) Int. Cl. G06Q 30/02; G06F 17/30

(52) U.S. Cl. CPC G06Q 30/0204; G06F 17/30598

(57) ABSTRACT

Embodiments are disclosed that determine the priority of customer demographic attributes of mixed attribute types. In one embodiment, a computerized data structure is retrieved that has sales data and demographic attribute data representing customers. Counts of the customers are grouped into first and second groups by applying a clustering algorithm to the sales data. Corresponding pairs of vector data structures are generated for each demographic attribute by distributing and normalizing the counts of the customers of each of the first and second groups across bins of first and second data structures. Priority values are generated by calculating a normalized distance measure between each corresponding pair of vector data structures corresponding to a same demographic attribute. Each priority value characterizes a level of priority, of a corresponding demographic attribute, with respect to segmenting the customers. A segmentation of the customers is controlled based on the priority values.

### BACKGROUND

Customer segmentation is the practice of dividing customers into groups that share similar characteristics relevant to marketing such as gender, age, education level, and spending habits. Retailers employ customer segmentation based on the idea that every customer has a different need, and that a customer can be better served by identifying and targeting groups with similar preferences.

Customer attributes are the main inputs to the process of customer segmentation. In the retail industry it is common to have tens or even hundreds of customer attributes. Consuming too many attributes is unfavorable and may cause segmentation results that are incorrect. That is mostly because of the effect known as the “curse of dimensionality”, which reduces the discerning power of the segmentation algorithm in classifying meaningful customer segments. Moreover, it makes it difficult to extract business insights from the generated segments.

Thus, it may be desirable to identify a subset of customer attributes that are most influential in the segmentation process. As customer attributes may contain both numerical and categorical attributes, any subset selection method should be able to take on both attribute types.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with an attribute prioritization tool;

FIG. 2 illustrates one embodiment of a method, which can be performed by the attribute prioritization tool of the computer system of FIG. 1, for identifying priority customer attributes among mixed attribute types;

FIG. 3 graphically illustrates an example embodiment of grouped customer data generated by the method of FIG. 2;

FIGS. 4-8 illustrate a specific example embodiment of identifying priority customer attributes among mixed-attribute types; and

FIG. 9 illustrates one embodiment of a computing device upon which an attribute prioritization tool of a computing system may be implemented.

### DETAILED DESCRIPTION

Computerized systems, methods, and other embodiments are disclosed that analyze computerized data to identify priority customer attributes among demographic attributes using a specified target attribute (e.g., customer sales). In one embodiment, the present computerized system is implemented to more efficiently identify (e.g., by using fewer computer resources of memory, processor time) customer attributes that are a priority, where the customer attributes can be used as inputs into a customer segmentation algorithm or tool.

In accordance with one embodiment, the computerized system includes a computer algorithm for analyzing and considering demographic attributes of both numerical and categorical attribute types, and a level of priority for each attribute is determined by the algorithm. For each attribute under consideration, customer's counts are distributed across attribute bins and are normalized for two different groups of customers (e.g., high-spending customers and low-spending customers), forming normalized distribution vectors as vector data structures which are stored in a memory. Priority values are derived from the vector data structures for each attribute. The priority values are ranked and the demographic attributes corresponding to the highest ranking priority values are selected to be used as inputs to a customer segmentation algorithm (e.g., a clustering algorithm).

The following terms are used herein with respect to various embodiments.

The term “item” or “retail item”, as used herein, refers to merchandise sold, purchased, and/or returned in a sales environment.

The terms “period”, “time period”, “retail period”, or “calendar period”, as used herein, refer to a unit increment of time (e.g., a 7-day week) which sellers use to correlate seasonal periods from one year to the next in a calendar for the purposes of planning and forecasting. The terms may be used interchangeably herein.

The term “sales channel” or “location” or “retail location”, as used herein, may refer to a physical store where an item is sold, or to an on-line store via which an item is sold.

The term “demographic attribute data”, as used herein, refers to computerized numerical and/or non-numerical data (e.g., categorical data) attributed to customers. For example, demographic attribute data may refer to age data, household size data, income level data, occupation data, gender data, and qualification data of customers.

The term “target attribute data”, as used herein, refers to computerized data associated with customers that is not demographic data. For example, target attribute data may refer to, for example, sales data (e.g., monetary and/or unit sales amounts) associated with customers.

The term “count”, as used herein with respect to a customer, refers to a representative instance of a customer. Therefore, the term “counts of a plurality of customers” refers to representative instances of multiple customers. The terms of “segmenting customers” and “segmenting the counts of the customers”, and like terms, may be used interchangeably herein.

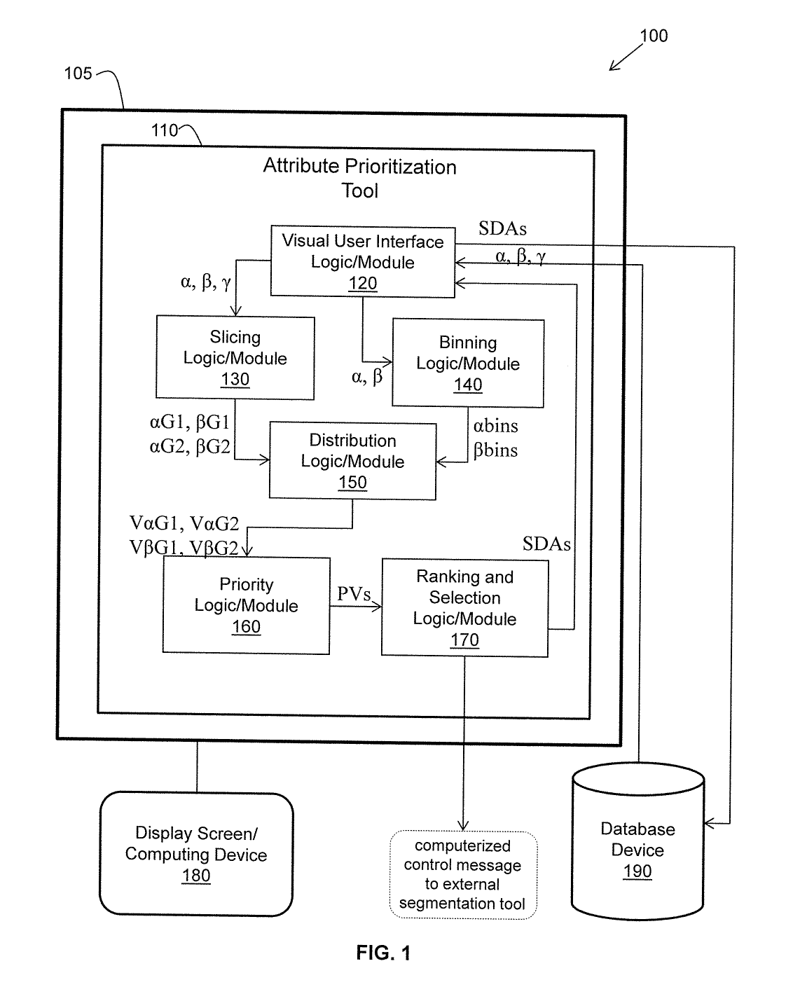

FIG. 1 illustrates one embodiment of a computer system 100, having a computing device 105 configured with an attribute prioritization tool 110 that is executable by a processor of the computing device 105. For example, in one embodiment, the attribute prioritization tool 110 may be part of a larger computer application (e.g., a computerized inventory management and demand forecasting application), configured to forecast and manage sales data, generate promotions, and/or control a computerized inventory data base for retail items at various retail locations based on customer demographics. The attribute prioritization tool 110 is configured to computerize the process of determining the priority attributes among a group of demographic customer attributes. The embodiments described herein take into consideration both numerical demographic attributes and categorical demographic attributes as input when performing the determination of what is a priority.

The attribute prioritization tool 110 is configured to computerize the process of analyzing data to rank attributes and segment customers based on the ranked attributes. In one embodiment, the system 100 is a computing/data processing system including at least one processor and a processor executable application or collection of distributed applications for enterprise organizations. The applications and computing system 100 may be configured to operate with or be implemented as a cloud-based networking system, a software-as-a-service (SaaS) architecture, or other type of computing solution.

In one embodiment, a computer algorithm is disclosed that implements an analytical approach for determining the level of priority of demographic attributes with respect to each other. It is assumed herein that both numerical and categorical demographic attribute data is available for use and that a cluster analysis model (clustering algorithm) is employed as part of a segmentation process that uses the output of this algorithm.

Customer segmentation can be an important driver of the supply chain and can greatly contribute to the accuracy of demand forecasts for retail items. If a forecast is inaccurate, allocation and replenishment perform poorly, resulting in financial loss for the retailer. Improvements in forecast accuracy for items may be achieved by the embodiments disclosed herein. Furthermore, a better understanding of the impact different segments of customers have on demand may be achieved. This helps the retailer to more effectively plan with respect to channel, pricing, promotions, and customer segments, for example.

With reference to FIG. 1, in one embodiment, the attribute prioritization tool 110 is implemented on the computing device 105 and includes logics or modules for implementing various functional aspects of the attribute prioritization tool 110. In one embodiment, the attribute prioritization tool 110 includes visual user interface logic/module 120, slicing logic/module 130, binning logic/module 140, distribution logic/module 150, priority logic/module 160, and ranking and selection logic/module 170.

Other embodiments may provide different logics or combinations of logics that provide the same or similar functionality as the attribute prioritization tool 110 of FIG. 1. In one embodiment, the attribute prioritization tool 110 is an executable application including algorithms and/or program modules configured to perform the functions of the logics. The application is stored in a non-transitory computer storage medium. That is, in one embodiment, the logics of the attribute prioritization tool 110 are implemented as modules of instructions stored on a computer-readable medium.

General Overview and Summary of the Logics/Modules

In one embodiment, visual user interface logic 120 is configured to facilitate the retrieving of numerical attribute data, categorical attribute data, and target attribute data associated with customers. Slicing logic 130 is configured to segment the customers into a first group and a second group based on the target attribute data. Binning logic 140 is configured to determine numerical bins for the numerical attributes and reduce or consolidate categorical bins for the categorical attributes.

Distribution logic 150 is configured to distribute customers (counts) across the numerical bins for the first group and the second group to form normalized distribution vectors (vector data structures). Distribution logic 150 is also configured to distribute the customers (counts) across the categorical bins for the first group and the second group to form normalized distribution vectors (vector data structures). A first vector data structure for the first group and a second vector data structure for the second group, corresponding to a same demographic attribute, constitute a corresponding pair of vector data structures.

Priority logic 160 is configured to generate priority values by calculating a normalized distance measure between each corresponding pair of vector data structures. Ranking and selection logic 170 is configured to numerically rank the priority values and select the demographic attributes (numerical and categorical attributes) corresponding to the highest ranked priority values. The selected demographic attributes (i.e., the most important demographic attributes) may be input to a segmentation tool to segment the customers.

System and Method Embodiments

The computer system 100 also includes a display screen 180 operably connected to the computing device 105. In accordance with one embodiment, the display screen 180 is implemented to display views of and facilitate user interaction with a graphical user interface (GUI) generated by visual user interface logic 120 for viewing and updating information associated with identifying priority customer demographic attributes. The graphical user interface may be associated with an attribute prioritization application and visual user interface logic 120 may be configured to generate the graphical user interface.

In one embodiment, the computer system 100 is a centralized server-side application that provides at least the functions disclosed herein and that is accessed by many users via computing devices/terminals communicating with the computer system 100 (functioning as the server) over a computer network. Thus the display screen 180 may represent multiple computing devices/terminals that allow users to access and receive services from the attribute prioritization tool 110 via networked computer communications.

In one embodiment, the computer system 100 further includes at least one database device 190 operably connected to the computing device 105 and/or a network interface to access the database device 190 via a network connection. For example, in one embodiment, the database device 190 is operably connected to visual user interface logic 120. In accordance with one embodiment, the database device 190 is configured to store and manage data structures associated with the attribute prioritization tool 110 in a database system (e.g., a computerized inventory management and demand forecasting application). The data structures may include, for example, records of numerical demographic attribute data, categorical demographic attribute data, and sales data associated with customers.

Referring back to the logics of the attribute prioritization tool 110 of FIG. 1, in one embodiment, visual user interface logic 120 is configured to generate a graphical user interface (GUI) to facilitate user interaction with the attribute prioritization tool 110. For example, visual user interface logic 120 includes program code that generates and causes the graphical user interface to be displayed based on an implemented graphical design of the interface. In response to user actions and selections via the GUI, associated aspects of identifying priority demographic customer attributes may be manipulated.

For example, in one embodiment, visual user interface logic 120 is configured to facilitate receiving inputs and reading data in response to user actions. For example, visual user interface logic 120 may facilitate retrieving (selection, reading, and inputting) of demographic attribute data (α and β in FIG. 1) and sales data (γ in FIG. 1) associated with customers. The demographic attribute data and the sales data may reside in data structures (e.g., within database device 190) associated with (and accessible by) an attribute prioritization application (e.g., the attribute prioritization tool 110) via the graphical user interface. The data may be read into data structures in a memory associated with visual user interface logic 120, for example. Determining the relative level of priority between demographic attributes takes into consideration both types of demographic attributes by operating upon both numerical attribute data α and categorical attribute data β.

Numerical attribute data α may include, for example, data representing the age, household size, and income level of customers. Categorical attribute data β may include, for example, data representing the gender, occupation, and qualification (e.g., education level or degree) of customers. Categories of gender may include, for example, “male”, “female”, and “transgender”. Categories of occupation may include, for example, “retired”, “executive”, “teacher”, “housewife”, “employee”, “student”, and “other”. Categories of education (qualification) may include, for example, “diploma”, “below average”, “bachelor's degree”, and “other”.

Target attribute data γ may be associated with the customers as well. For example, in one embodiment, target attribute data γ includes sales data (e.g., sales amounts (either monetary amounts or numbers of items purchased) associated with each customer. The target attribute data γ may be segmented into retail periods of past weeks, with each past week having numerical values assigned to it to indicate the sales generated that week for each customer. The demographic attribute data (α and β) and the target attribute data γ for customers may be accessed via network communications, in accordance with one embodiment.

In one embodiment, visual user interface logic 120 is also configured to facilitate the outputting and displaying of prioritized (ranked) and selected demographic attributes (SDAs), via the graphical user interface, on the display screen 180. In one embodiment, ranking and selection logic 170 is configured to operably interact with visual user interface logic 120 to facilitate displaying of prioritized (ranked) and selected demographic attributes (SDAs) of an output data structure. Furthermore, in one embodiment, slicing logic 130 is configured to operably interact with visual user interface logic 120 to receive demographic attribute data (α and β) and target attribute data γ, as illustrated in FIG. 1. Binning logic 140 is configured to operably interact with visual user interface logic 120 to receive demographic attribute data (α and β), as illustrated in FIG. 1.

Referring again to FIG. 1, in one embodiment, slicing logic 130 is configured to group customers, as represented by at least counts of the customers, into a first group and a second group by applying a clustering algorithm to the target attribute data γ. The target attribute data γ is numerical data which can be operated upon by, for example, a K-Means clustering algorithm, in accordance with one embodiment. When the target attribute data γ is sales data, the customers may be grouped into a high-spending group (the first group G1) and a low-spending group (the second group G2), for example.

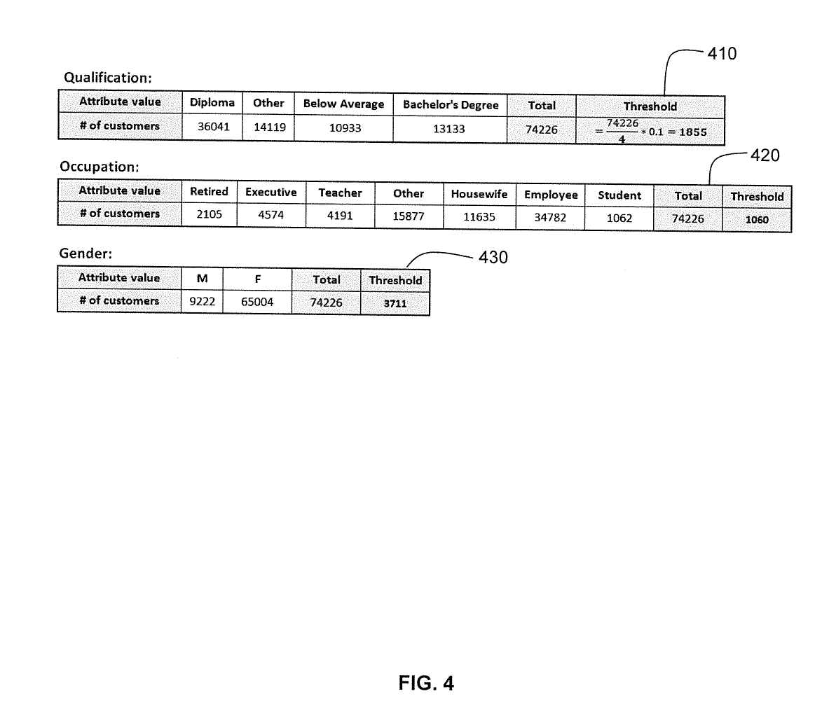

Grouping the customers into two groups based on the target attribute establishes a basis for determining the priority of the various demographic attributes associated with the customers. As a result of the grouping, the first group of customers G1 is associated with numerical attribute data αG1 and categorical attribute data βG1 for the first group. Similarly, the second group of customers G2 is associated with numerical attribute data αG2 and categorical attribute data βG2 for the second group. Details of performing the grouping are discussed herein with respect to at least one of the “Details of One Algorithmic Embodiment” section, the “Algorithm Description” section, the “Specific Example” section, and FIGS. 4-8.

In one embodiment, binning logic 140 is configured to, for each demographic attribute, determine bins across which the customers are to be distributed and normalized according to customer count. For example, in one embodiment, binning logic 140 is configured to, for each numerical attribute, determine multiple numerical bins αbins over which the counts of the customers associated with the numerical attribute data α are to be distributed. Also, binning logic 140 is configured to, for each categorical attribute, filter the categorical attribute data β to reduce a number of categorical bins βbins over which the counts of the customers associated with the categorical attribute data β are to be distributed. Details of performing binning and filtering are discussed herein with respect to at least one of the “Details of One Algorithmic Embodiment” section, the “Algorithm Description” section, the “Specific Example” section, and FIGS. 4-8.

In one embodiment, distribution logic 150 is configured to generate a corresponding pair of vector data structures for each demographic attribute of the multiple demographic attributes. For example, the first customer group G1 may be distributed and normalized across the bins of a first data structure of each of the demographic attributes. Also, the second customer group G2 may be distributed and normalized across the bins of a second data structure of the same particular demographic attribute. As a result, a first data structure and a second data structure, having the distributed and normalized customer count data, constitute a corresponding pair of vector data structures for the particular demographic attribute. Similarly, a corresponding pair of vector data structures is generated for each demographic attribute.

For example, in one embodiment, distribution logic 150 is configured to, for the first group G1 and the second group G2, form first and second normalized distribution vectors (VαG1 for group 1 and VαG2 for group 2). This is accomplished by distributing and normalizing counts of customers associated with the numerical attribute data αG1 and αG2 across the multiple numerical bins αbins for each numerical attribute. That is, a first normalized distribution vector VαG1 is formed for each numerical attribute of the multiple numerical attributes for group G1, and a second normalized distribution vector VαG2 is formed for each numerical attribute of the multiple numerical attributes for group G2. The first and second normalized distribution vectors (VαG1 and VαG2) constitute a corresponding pair of vector data structures for a particular numerical demographic attribute.

Similarly, in one embodiment, distribution logic 150 is configured to, for the first group G1 and the second group G2, form first and second normalized distribution vectors (VβG1 for group 1 and VβG2 for group 2). This is accomplished by distributing and normalizing counts of customers associated with the categorical attribute data βG1 and βG2 across the multiple categorical bins βbins for each categorical attribute. That is, a first normalized distribution vector VβG1 is formed for each categorical attribute of the multiple categorical attributes for group G1, and a second normalized distribution vector VβG2 is formed for each categorical attribute of the multiple categorical attributes for group G2. The first and second normalized distribution vectors (VβG1 and VβG2) constitute a corresponding pair of vector data structures for a particular categorical demographic attribute. Details of performing distribution and normalization are discussed herein with respect to at least one of the “Details of One Algorithmic Embodiment” section, the “Algorithm Description” section, the “Specific Example” section, and FIGS. 4-8.

In one embodiment, priority logic 160 is configured to generate multiple priority values (PVs in FIG. 1) by calculating a normalized distance measure between each corresponding pair of vector data structures, corresponding to a same demographic attribute, for each of the multiple demographic attributes. In accordance with one embodiment, the distance measure is based on a Euclidean distance measure. Each priority value of the multiple priority values characterizes a level of priority, with respect to segmenting the customers, of a corresponding demographic attribute. Details of generating priority values are discussed herein with respect to at least one of the “Details of One Algorithmic Embodiment” section, the “Algorithm Description” section, the “Specific Example” section, and FIGS. 4-8.

In one embodiment, ranking and selection logic 170 is configured to rank the multiple priority values (PVs) out of priority logic 160. The ranking is accomplished by numerically ordering the multiple priority values. Ranking and selection logic 170 is also configured to select a subset of the multiple demographic attributes corresponding to the highest ranked priority values. For example, in one embodiment, a selection value may be set to select a number of highest ranking demographic attributes corresponding to the selection value (e.g., the selection value may be ten (10) when there are more than twenty (20) total demographic attributes).

The demographic attributes in the subset (the selected demographic attributes or SDAs in FIG. 1) are considered to be the most important demographic attributes of the multiple demographic attributes. Demographic attribute data corresponding to the subset, as selected, is identified as an input into, for example, a clustering algorithm of an external segmentation tool. Details of performing ranking and selection are discussed herein with respect to at least one of the “Details of One Algorithmic Embodiment” section, the “Algorithm Description” section, the “Specific Example” section, and FIGS. 4-8.

In one embodiment, ranking and selection logic 170 is configured to generate and transmit a computerized control message, via network communications, to an external segmentation tool. The computerized control message directs the segmentation tool to perform a segmentation of the customers by applying a clustering algorithm to the demographic attribute data corresponding to the selected subset of demographic attributes.

In this manner, only the most important demographic attributes are used to segment the customers into useful groups. Consuming all the available demographic attributes is often unfavorable and may have an adverse effect on segmentation results. Moreover, it makes it difficult to extract business insights from the generated segments. Attribute prioritization tool 110 identifies those customer attributes that result in the most useful customer segments, even if the customer attributes are of mixed-types.

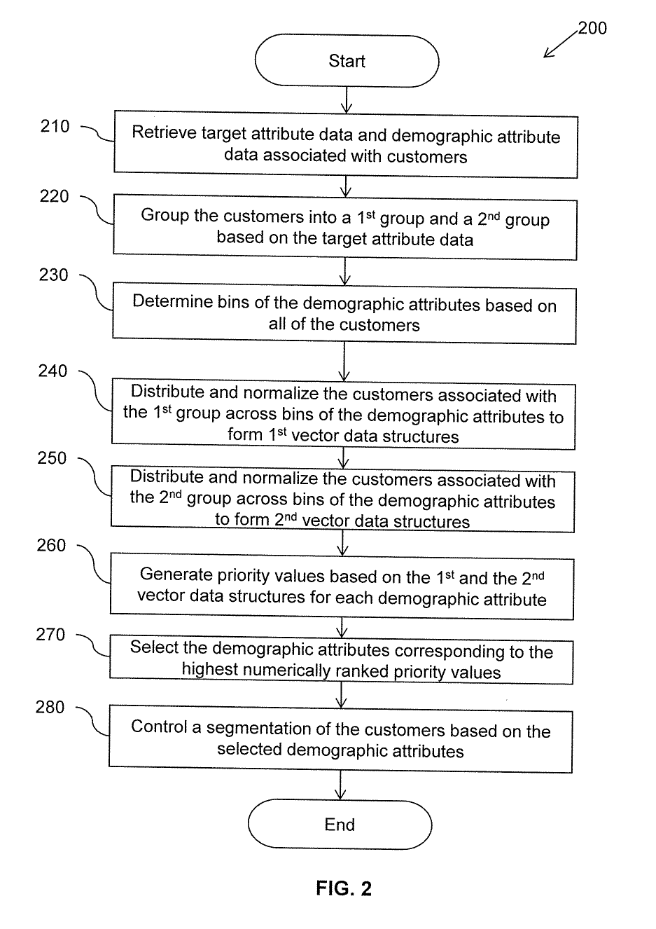

FIG. 2 illustrates one embodiment of a computer-implemented method 200, which can be performed by the attribute prioritization tool 110 of the computer system 100 of FIG. 1, for prioritizing demographic customer attributes. Method 200 describes operations of the attribute prioritization tool 110 and is implemented to be performed by the attribute prioritization tool 110 of FIG. 1, or by a computing device configured with an algorithm of the method 200. For example, in one embodiment, method 200 is implemented by a computing device configured to execute a computer application via at least a processor. The computer application is configured to process data in electronic form and includes stored executable instructions that perform the functions of method 200 when executed by the processor.

Method 200 will be described from the perspective that, for customers of a retail enterprise, demographic attribute data of multiple types and forms can be collected and analyzed to group the customers based on a target attribute such as, for example, sales. The priority demographic attributes can be identified and the associated demographic attribute data can be input into a segmentation process to segment the customers to, for example, contribute to the accuracy of demand forecasts for retail items.

Demographic attribute data may include both numerical demographic attribute data and categorical demographic attribute data. It is assumed herein that the demographic attribute data and the target attribute data have been recorded for multiple customers that have purchased retail items of the retail enterprise in past retail periods (e.g., over 52 weeks of the past year). The demographic and target attribute data may be stored in the database device 190, for example. In accordance with one embodiment, the attribute prioritization tool 110 is configured to retrieve demographic and target attribute data for customers from at least one data structure (e.g., from data structures in the database device 190).

Again, numerical demographic attribute data may include, for example, age data, household size data, and income level data associated with multiple customers. Categorical demographic attribute data may include, for example, gender data occupation data, and qualification data associated with the multiple customers. Target attribute data may include, for example, sales data having sales amounts for each customer of the multiple customers.

Upon initiating method 200, at block 210, a computerized data structure stored in memory is retrieved. The computerized data structure has sales data (target data) representing a target attribute for each customer of multiple customers, and demographic attribute data representing multiple demographic attributes for each customer of the multiple customers. The retrieving may be performed by visual user interface logic 120 of the attribute prioritization tool 110, in accordance with one embodiment. The attribute data may reside in and be retrieved from a data structure stored in a memory of the computing device 105, for example. Alternatively, the attribute data may reside in and be retrieved from a data structure stored in a memory of the database device 190. The attribute data may be read into a data structure associated with visual user interface logic 120, for example.

The attribute data (numerical demographic, categorical demographic, target) is associated with multiple customers. The categorical demographic attribute data (e.g., occupation, gender, qualification) is typically in a different form (e.g., text) than the form (numeric) of the numerical demographic attribute data (e.g., age, household size, income level). Furthermore, the target attribute data, if sales data, is typically in numeric form (e.g., sales dollars and/or sales quantities).

Referring again to FIG. 2, at block 220, the customers, as represented by counts of the customers, are grouped or sliced into a first group and a second group by applying a clustering algorithm to the sales data. Cluster analysis is an analytical technique of grouping data that is representative of objects (e.g., customers) based on information within the data that characterizes the objects and the relationships between the objects. Ideally, groups formed by cluster analysis put similar or related objects in a same group, and put dissimilar or unrelated objects in different groups. The clustering of objects is more distinct when similarities are greater within groups and the differences are greater between groups.

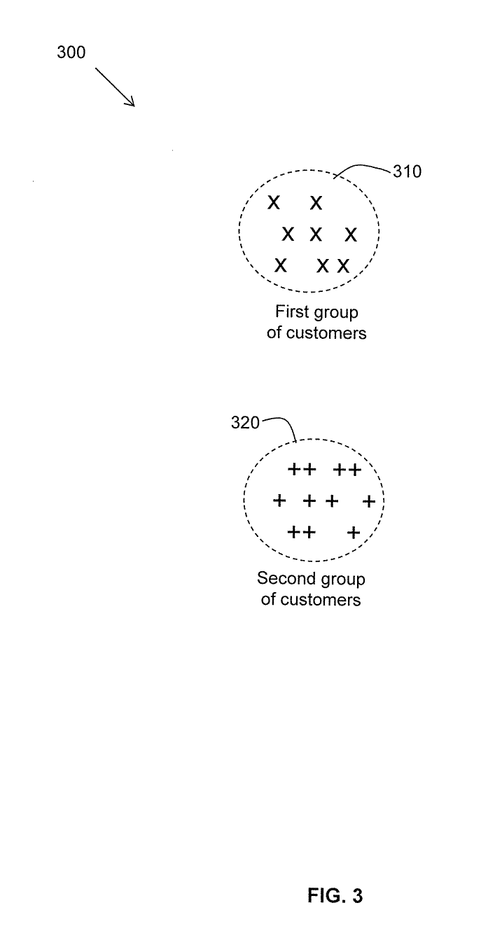

In one embodiment, the cluster analysis is performed by a cluster algorithm implemented by slicing logic 130 of the attribute prioritization tool 110. The cluster analysis effectively slices the customers counts associated with the sales data into two groups, where each group of customers exhibits a particular behavior or characteristic. For example, the first group may represent customers that spend more money than the second group of customers. FIG. 3 illustrates, in graph 300, such an example of grouped customer data generated by method 200 of FIG. 2. In FIG. 3, each “x” represents a customer in the “higher-spending” group 310 and each “+” represents a customer in the “lower-spending” group 320.

In one embodiment, a clustering technique (algorithm) known as K-means is used to perform the cluster analysis, where a number of desired clusters, K, can be specified. Initially, K number of centroids are established in a data domain, and each data point (e.g., representing a customer) is assigned to a closest centroid within the data domain. In accordance with one embodiment, the data domain is defined based on the nature of the attribute data. The centroid of each cluster is updated based on the data points assigned to the cluster. The assigning and updating process is repeated until the centroids no longer change (or change within some specified tolerance). Other clustering techniques are possible as well, in accordance with other embodiments. Details of performing clustering are discussed herein with respect to at least one of the “Details of One Algorithmic Embodiment” section, the “Algorithm Description” section, the “Specific Example” section, and FIGS. 4-8.

At block 230, for each demographic attribute, a data structure is divided into bins (e.g., data fields). That is, multiple bins of a data structure are determined based on the demographic attribute data of all of the customers, across which the first group of customers (counts) associated with the demographic attribute data may be distributed and normalized. Similarly, the multiple bins of the data structure are determined based on the demographic attribute data of all of the customers, across which the second group of customers (counts) associated with the demographic attribute data may be distributed and normalized. In one embodiment, the binning of block 230 is performed by binning logic 140 of the attribute prioritization tool 110.

In one embodiment, data structures associated with the numerical demographic attributes are divided into N bins. The default number of bins is five (5) bins unless otherwise specified. A method based on equi-depth binning is used, in accordance with one embodiment. Performance may be improved by identifying and removing outlier data points from the demographic attribute data before binning. In one embodiment, at least 0.10*(100/N) percent of the customers associated with the numerical demographic attribute data should fall into each bin to obtain good performance. Otherwise, bins may be reconstructed using a lower N number.

In one embodiment, data structures associated with the categorical demographic attributes are divided into a number of bins based on the number of categories for each demographic attribute. However, categorical demographic attributes having more than twenty (20) distinct categories may be regrouped to at most twenty (20) bins, or be excluded from the clustering process, in accordance with one embodiment. At least 0.10*(100/number of bins) percent of the counts of the customers associated with the categorical demographic attribute data should fall into each bin to obtain good performance. In this manner, bins of data structures associated with the categorical demographic attributes are effectively reduced or filtered. Further details of performing binning are discussed herein with respect to at least one of the “Details of One Algorithmic Embodiment” section, the “Algorithm Description” section, the “Specific Example” section, and FIGS. 4-8.

At block 240, counts of the first group of customers are distributed and normalized across the bins of the demographic attributes to form first vector data structures (i.e., a first vector data structure for each demographic attribute). Similarly, at block 250, counts of the second group of customers are distributed and normalized across the bins of the demographic attributes to form second vector data structures (i.e., a second vector data structure for each demographic attribute). Normalization is performed with respect to customer count. In this manner, a corresponding pair of vector data structures is formed for each demographic attribute. In accordance with one embodiment, blocks 240 and 250 are performed by distribution logic 150 of the attribute prioritization tool 110. Details of performing distribution and normalization are discussed herein with respect to at least one of the “Details of One Algorithmic Embodiment” section, the “Algorithm Description” section, the “Specific Example” section, and FIGS. 4-8.

At block 260, multiple priority values are generated by calculating a normalized distance measure between each corresponding pair of vector data structures that correspond to a same demographic attribute. In one embodiment, the distance measure is based on a Euclidean distance measure. Each priority value characterizes a level of priority, of a corresponding demographic attribute, with respect to segmenting the customers. The priority values may be ranked by numerically ordering the priority values (e.g., from highest value to lowest value). In one embodiment, the multiple priority values are generated by priority logic 160 of the attribute prioritization tool 110. Details of calculating the Euclidean distance are discussed herein with respect to at least one of the “Details of One Algorithmic Embodiment” section, the “Algorithm Description” section, the “Specific Example” section, and FIGS. 4-8.

At block 270, demographic attributes are selected based on the highest numerically ranked priority values (i.e., the most important demographic attribute values are selected). A higher ranking indicates a higher priority with respect to segmenting the customers. In one embodiment, the selected demographic attributes (and associated demographic attribute data) may be stored in an input data structure in the database device 190. Demographic attribute data identified as corresponding to the selected demographic attributes may be used as input data into an external segmentation tool to segment the customers based on demographic attributes. In one embodiment, the ranking of the priority values, the selecting of the demographic attributes, and the identifying of the corresponding demographic attribute data is performed by ranking and selection logic 170 of the attribute prioritization tool 110. Details of performing ranking and selection are discussed herein with respect to at least one of the “Details of One Algorithmic Embodiment” section, the “Algorithm Description” section, the “Specific Example” section, and FIGS. 4-8.

At block 280, segmentation of the customers by an external segmentation tool is controlled based on the selected demographic attributes. In one embodiment, a computerized control message is generated (e.g., by ranking and selection logic 170) and transmitted, via network communications, to an external segmentation tool. The control message causes the external segmentation tool to be applied to the demographic attribute data associated with the selected (i.e., most important) demographic attributes.

A computerized management system can use the results of the external segmentation tool to control at least one enterprise function performed by a computerized management system. For example, an inventory allocation function can be controlled by the segmented customer data to first direct available inventory towards sales channels where customers in a most-profitable group shop, before directing inventory to other sales channels. Such a computerized management system may be an enterprise resource planning (ERP) system or an inventory management and demand forecasting system, for example.

Details of One Algorithmic Embodiment

In one embodiment, the goal is to determine which demographic attributes associated with customers have the highest priority, with respect to segmenting the customers in a more effective way. Inputs include a set of customer attributes for priority evaluation: {A₁, . . . ,Aₙ}, a number of required priority attributes, m, and a target attribute, in the form of sales in a particular category: A_{T}. Outputs include a set of priority attributes in the order of priority: {A₍₁₎, . . . ,A₍ₙ₎}, where m≦n and A₍ᵢ₎ represents the i^{th} priority attribute.

The algorithm evaluates the customer attributes A₁ to Aₙ with respect to the target attribute A_{T}, and ranks them in order of priority to use as input for the customer segmentation tool. The target attribute, which is selected by the business user, is a customer purchase related attribute such as sales dollars in a particular category.

The following notations are used herein:

Cust: Set of all the customers

|Cust|: Total number of customers

aᵢ^{c}: Value of attribute Aᵢ for customer cεCust

|Aᵢ|Number of distinct values of attribute Aᵢ

aᵢⱼ: Value j of attribute Aᵢ, jε{1, . . . , |Aᵢ|}

Bᵢ^{b}: Set of Aᵢ attribute values that fall in bin b, bε{1, . . . , Nᵢ}

Hᵢ^{N}: Normalized group 1 (high-spending) vector for attribute Aᵢ

hᵢⱼ^{N}: j^{th} element of the Hᵢ^{N} vector

Lᵢ^{N}: Normalized group 2 (low-spending) vector for attribute Aᵢ

lᵢⱼ^{N}: j^{th} element of the Lᵢ^{N} vector

Iᵢ: Priority of attribute Aᵢ (priority value)

Algorithm Steps:

Step 1: The customers are divided into two groups using the K-means clustering algorithm with A_{T} as the input. The resulting groups are Cust^{H}, which are high-spending customers (1^{st} group), and Cust^{L}, which are low-spending customers (2^{nd} group).

Step 2: For each Aᵢ:
a. If Aᵢ is categorical:
   i. If |Aᵢ|>20: reduce |Aᵢ| by binning attribute values, or else exclude Aᵢ from the output.
   ii. For all jε{1, . . . , |Aᵢ|}:

$$If Count ( c ∈ Cust \vert {a}_{i}^{c} = {a}_{ij} ) < \frac{\vert Cust \vert}{\vert {A}_{i} \vert} * 0.1 ,$$

perform the first possible of the following:
   a. Merge aᵢⱼ with another aᵢₖ, k≠j
   b. Exclude aᵢⱼ from Aᵢ
   c. Exclude Aᵢ from the output

b. If Aᵢ is numerical:
i. N=5
ii. Bᵢ^{b}=distinct values in bin b from equi-depth binning of aᵢ^{c} values, cεCust, bε{1, . . . , N}
iii. For bε{1, . . . , N}, If (Bᵢ^{b}∩Bᵢ^{b+1})=Bᵢ^{b} or Bᵢ^{b+1}, merge b+1 into b.
iv. For bε{1, . . . ,N}, If (Bᵢ^{b}∩Bᵢ^{b+1})≠Ø, Bᵢ^{b},Bᵢ^{b+1}, remove each value in (Bᵢ^{b}∩Bᵢ^{b+1}) from the bin that has the lower number of associated customers.
v. For all bεN, If

$$Count ( c ∈ Cust \vert {a}_{i}^{c} ∈ {B}_{i}^{b} ) < \frac{\vert Cust \vert}{N} * 0.1 ,$$

then:
   N=N−1
   Go to step 2-b-iii
vi. If N=1, remove Aᵢ from the output.
   vii. Nᵢ=N
Step 3: For all iε{1, . . . , |Aᵢ|}:

$${H}_{i}^{N} = [ \frac{Count ( c ∈ {Cust}^{U} \vert {a}_{i}^{c} ∈ {B}_{i}^{b} )}{Count ( c ∈ {Cust}^{U} )} f or b ∈ \{ 1 , … , {N}_{i} \} ]$$

$${L}_{i}^{N} = [ \frac{Count ( c ∈ {Cust}^{L} \vert {a}_{i}^{c} ∈ {B}_{i}^{b} )}{Count ( c ∈ {Cust}^{U} )} f or b ∈ \{ 1 , … , {N}_{i} \} ]$$

Step 4: Iᵢ=\sqrt{Nᵢ}*{square root over (Σ_{jε{1, . . . , N}_{ᵢ}_{}}(hᵢⱼ^{N}−lᵢⱼ^{N})²)}
Step 5: Rank Aᵢ's in decreasing order of the corresponding Iᵢ values (priority values). An attribute Aᵢ with a higher rank position is of higher priority.
Step 6: Output A₍ⱼ₎=Aᵢ, where Aᵢ has the j^{th} rank among all Aᵢ's, for j≦m.

Algorithm Description:

Step 1: Divide customers into two groups, group 1 (high-spending) and group 2 (low-spending), using the values of the target attribute.

Step 2: Filtering and binning:

a. Categorical attributes with more than 20 distinct values are to be either regrouped to a maximum of 20 bins or else be excluded from the output. There is to be at least

$$0.1 * \frac{100}{number of attribute values} \%$$

of the customers associated with each attribute value. The attribute values that contribute to a lower number of customers are to be either regrouped with other values or excluded from the attribute values. Otherwise, the whole attribute should be excluded from the output.

b. Group each numerical attribute into at most N bins using equi-depth binning. The default number for the initial N is 5, unless otherwise specified. In equi-depth binning, customers are first sorted in increasing order of the associated attribute values and then are divided into N evenly numbered groups. The bins are then constructed from the distinct attribute values in each of the N groups. An attribute value can be present in more than one bin as a result of equi-depth binning. In that case, that value is only preserved in the bin which has the highest number of associated customers and is eliminated from the other bins. If a bin becomes empty as a result of this process, it is simply removed from the bins. The same threshold check that was used in part a. is performed on the attribute bins and, if a bin does not meet the threshold, N is reduced by one (1) and the whole process from step a. is repeated. If N decrements to one (1), the attribute will be excluded from the output. To improve the accuracy, outliers should be removed from attribute values before binning.

Step 3: For each attribute, the distribution of the number of customers across the attribute values is obtained, separately for group 1 customers and group 2 customers. Each distribution is normalized so that its values add up to unity.

Step 4: The priority number (priority value) of an attribute is then derived by calculating the normalized Euclidean distance between the group 1 and the group 2 vectors of that attribute. The normalization factor for each attribute is the square root of the number of bins.

Step 5: The attributes are ranked in decreasing order of the corresponding priority value. A higher rank indicates a higher priority.

Step 6: The desired number of priority attributes (e.g., the top ten (10)) is selected from all of the attributes for attribute priority output, which will be the input to the customer segmentation process.

### Specific Example

The following example demonstrates the method using the data from a fashion retailer for the Knitwear category. Four attributes are available for priority evaluation.

Age: Range of numbers between 20 and 85

Gender: M, F

Qualification: Below Average, Diploma, Bachelor's Degree, Other

Occupation: Employee, Housewife, Executive, Retired, Student, Teacher, Other.

In the first step, customers are divided into a first group (high-spending) and a second group (low-spending). The output of clustering shows $44.6 as the dividing point, meaning that all the customers with a total purchase value of $44.6 and lower fall into the second group. The rest of the customers are in the first group. There exist three categorical attributes and one numerical attribute among the inputs. Categorical attributes are checked for a minimum threshold value as shown in the tables 410, 420, and 430 of FIG. 4.

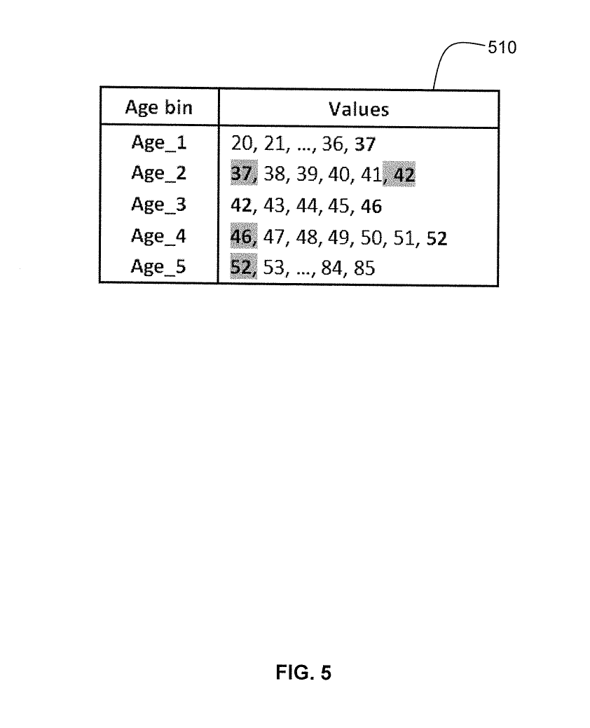

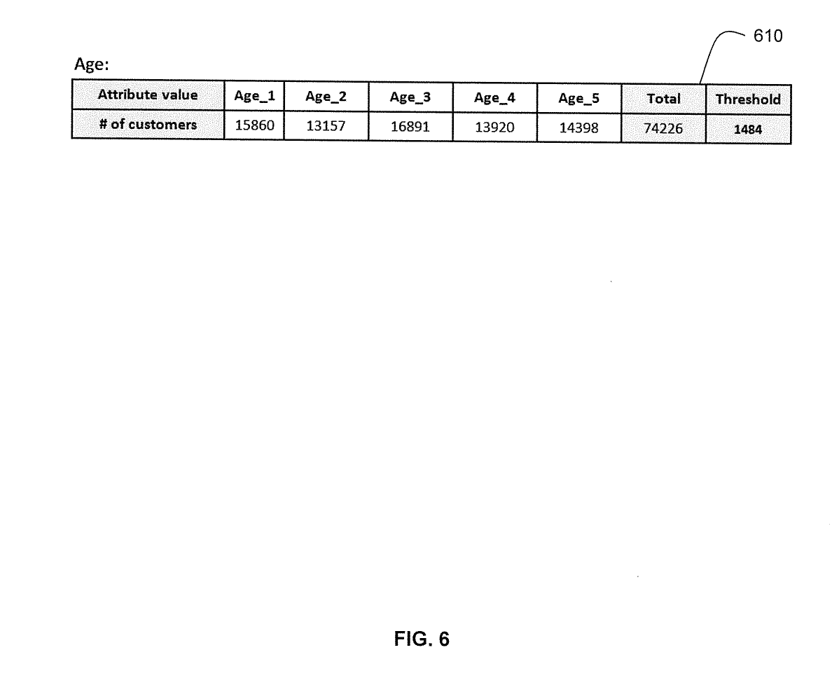

All of the attribute values are above the minimum threshold and, therefore, no further action is required. In the next step, the age numerical attribute is binned using equi-depth binning as shown in the table 510 of FIG. 5. Values 37, 42, 46 and 52 are present in more than one bin and will be preserved in the bin with the most number of associated customers and eliminated from the rest (grayed out in FIG. 5). Next, the binned age attribute is checked for the threshold value as shown in table 610 of FIG. 6. The binned age attribute also meets the requirement.

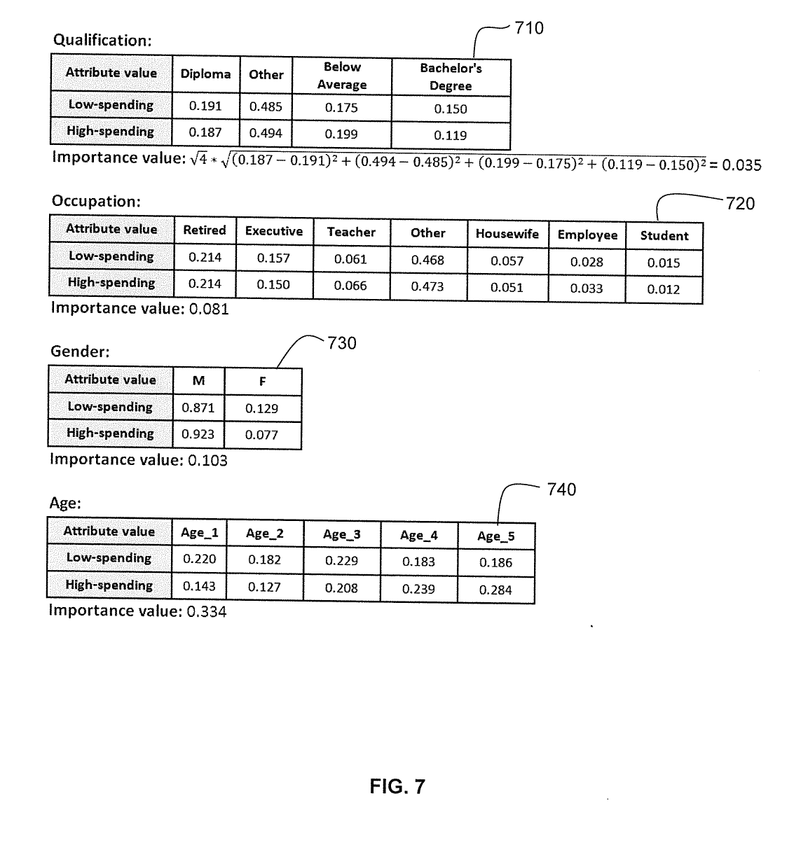

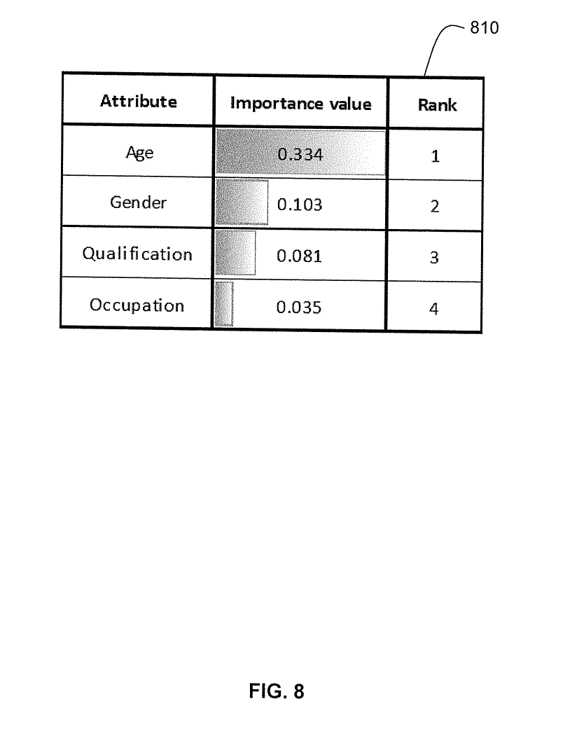

Next, the normalized distribution of the number of customers among the values of each attribute is computed, separately for group 1 and group 2 customers. Then, the attribute priority (priority value) is calculated using the formula in step 4. Tables 710-740 of FIG. 7 show the calculations for the four (4) attributes. Finally, using the priority values, the input attributes are ranked as shown in table 810 of FIG. 8.

In this manner, the demographic attributes (whether numerical or categorical) that are most important with respect to segmenting the customer data can be determined and used as inputs to a segmentation tool. Customer segmentation can be an important driver of the supply chain and can greatly contribute to the accuracy of demand forecasts for retail items. If a forecast is inaccurate, allocation and replenishment perform poorly, resulting in financial loss for the retailer. Improvements in forecast accuracy for items may be achieved by the embodiments disclosed herein. Furthermore, a better understanding of the impact different segments of customers have on demand may be achieved. This helps the retailer to more effectively plan with respect to channel, pricing, promotions, and customer segments, for example.

Computing Device Embodiment

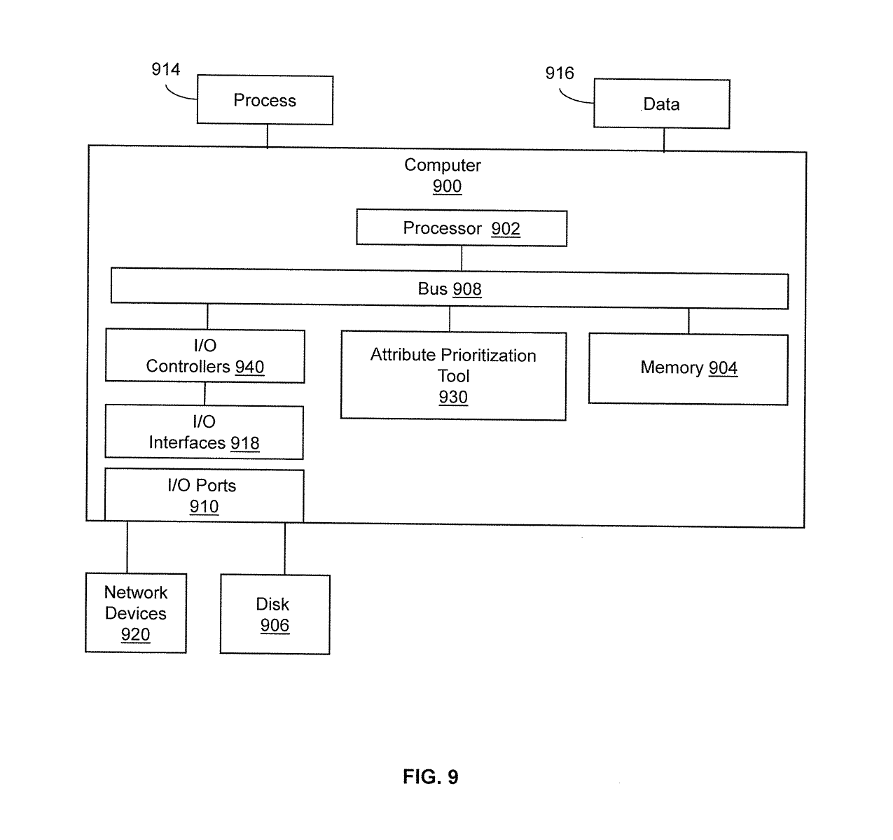

FIG. 9 illustrates an example computing device that is configured and/or programmed with one or more of the example systems and methods described herein, and/or equivalents. FIG. 9 illustrates one example embodiment of a computing device upon which an embodiment of an attribute prioritization tool may be implemented. The example computing device may be a computer 900 that includes a processor 902, a memory 904, and input/output ports 910 operably connected by a bus 908.

In one example, the computer 900 may include attribute prioritization tool 930 (corresponding to attribute prioritization tool 110 from FIG. 1) configured with a programmed algorithm as disclosed herein to prioritize demographic customer attributes to be used in customer segmentation. In different examples, the tool 930 may be implemented in hardware, a non-transitory computer-readable medium with stored instructions, firmware, and/or combinations thereof. While the tool 930 is illustrated as a hardware component attached to the bus 908, it is to be appreciated that in other embodiments, the tool 930 could be implemented in the processor 902, a module stored in memory 904, or a module stored in disk 906.

In one embodiment, tool 930 or the computer 900 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the generation of prioritized demographic attributes. The means may also be implemented as stored computer executable instructions that are presented to computer 900 as data 916 that are temporarily stored in memory 904 and then executed by processor 902.

Tool 930 may also provide means (e.g., hardware, non-transitory computer-readable medium that stores executable instructions, firmware) for facilitating the generation of prioritized demographic attributes for both numerical and categorical demographic attributes together.

Generally describing an example configuration of the computer 900, the processor 902 may be a variety of various processors including dual microprocessor and other multi-processor architectures. A memory 904 may include volatile memory and/or non-volatile memory. Non-volatile memory may include, for example, ROM, PROM, and so on. Volatile memory may include, for example, RAM, SRAM, DRAM, and so on.

A storage disk 906 may be operably connected to the computer 900 via, for example, an input/output interface (e.g., card, device) 918 and an input/output port 910. The disk 906 may be, for example, a magnetic disk drive, a solid state disk drive, a floppy disk drive, a tape drive, a Zip drive, a flash memory card, a memory stick, and so on. Furthermore, the disk 906 may be a CD-ROM drive, a CD-R drive, a CD-RW drive, a DVD ROM, and so on. The memory 904 can store a process 914 and/or a data 916, for example. The disk 906 and/or the memory 904 can store an operating system that controls and allocates resources of the computer 900.

The computer 900 may interact with input/output devices via the i/o interfaces 918 and the input/output ports 910. Input/output devices may be, for example, a keyboard, a microphone, a pointing and selection device, cameras, video cards, displays, the disk 906, the network devices 920, and so on. The input/output ports 910 may include, for example, serial ports, parallel ports, and USB ports.

The computer 900 can operate in a network environment and thus may be connected to the network devices 920 via the i/o interfaces 918, and/or the i/o ports 910. Through the network devices 920, the computer 900 may interact with a network. Through the network, the computer 900 may be logically connected to remote computers. Networks with which the computer 900 may interact include, but are not limited to, a LAN, a WAN, and other networks.

Systems, methods, and other embodiments have been described that are configured to determine the priority of customer attributes with respect to customer segmentation. In one embodiment, visual user interface logic is configured to facilitate the reading of sales data representing a target attribute for each customer of multiple customers and demographic attribute data representing multiple demographic attributes for each customer of the multiple customers. Slicing logic is configured to group the multiple customers into a first group and a second group by applying a clustering algorithm to the sales data. Distribution logic is configured to generate a corresponding pair of vector data structures for each demographic attribute of the multiple demographic attributes. A corresponding pair of vector data structures is generated by distributing and normalizing customer counts associated with the first group and the second group, respectively, across multiple bins of a demographic attribute. Priority logic is configured to generate multiple priority values by calculating a normalized distance measure between each corresponding pair of vector data structures corresponding to a same demographic attribute of the multiple demographic attributes. Each priority value characterizes a level of priority, with respect to segmenting the customers, of a corresponding demographic attribute.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). An operable connection may include one entity generating data and storing the data in a memory, and another entity retrieving that data from the memory via, for example, instruction control. Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A computer-implemented method performed by a computing device where the computing device includes at least a processor for executing instructions from a memory, the method comprising:
retrieving at least one computerized data structure, stored in a computerized memory, having sales data representing a target attribute for each customer of a plurality of customers and demographic attribute data representing a plurality of demographic attributes for each customer of the plurality of customers;
grouping the plurality of customers, as represented by at least counts of the plurality of customers, into a first group and a second group by applying a clustering algorithm to the sales data via at least one processor;
generating a corresponding pair of vector data structures, via the at least one processor, for each demographic attribute of the plurality of demographic attributes;
generating a plurality of priority values by calculating a normalized distance measure, via the at least one processor, between each corresponding pair of vector data structures corresponding to a same demographic attribute of the plurality of demographic attributes; and
based on the plurality of priority values, controlling a segmentation of the counts of the plurality of customers by generating and transmitting a computerized control message, via network communications, to an external segmentation tool to cause the external segmentation tool to be applied to the demographic attribute data associated with at least one demographic attribute of the plurality of demographic attributes.

2. The method of claim 1, further comprising, for each demographic attribute of the plurality of demographic attributes:
determining, via the at least one processor, a plurality of bins across which counts of the first group of customers and counts of the second group of customers associated with the demographic attribute data are to be distributed and normalized, wherein the plurality of bins are derived from the demographic attribute data from each of the plurality of customers;
distributing and normalizing the counts of the first group of customers across the plurality of bins in a first data structure as part of the generating a corresponding pair of vector data structures; and
distributing and normalizing the counts of the second group of customers across the plurality of bins in a second data structure as part of the generating a corresponding pair of vector data structures.

3. The method of claim 1, wherein the sales data comprises at least one of numbers of units sold or monetary sales amounts.

4. The method of claim 1, wherein the demographic attribute data includes numerical attribute data that includes at least one of age data, household size data, and income level data for each of the customers.

5. The method of claim 1, wherein the demographic attribute data includes categorical attribute data that includes at least one of occupation data, gender data, and qualification data for each of the customers.

6. The method of claim 1, wherein the distance measure is based on a Euclidean distance measure.

7. The method of claim 1, further comprising:
identifying, via the at least one processor, outlier data points within the demographic attribute data; and
removing the outlier data points from the demographic attribute data.

8. The method of claim 1, wherein the clustering algorithm is a K-Means clustering algorithm.

9. The method of claim 1, further comprising:
ranking the plurality of priority values, via the at least one processor, by numerically ordering the plurality of priority values;
selecting the at least one demographic attribute corresponding to at least a highest ranked priority value of the plurality of priority values; and
identifying the demographic attribute data corresponding to the at least one demographic attribute, as selected, as an input to the external segmentation tool to segment the counts of the plurality of customers.

10. The method of claim 9, further comprising storing the demographic attribute data corresponding to the at least one demographic attribute, as selected, in at least one input data structure in a database device.

11. A computing system, comprising:
a visual user interface module stored in a non-transitory computer-readable medium and including executable instructions configured to facilitate retrieving, from a memory, sales data representing a target attribute for each customer of a plurality of customers and demographic attribute data representing a plurality of demographic attributes for each customer of the plurality of customers;
a slicing module stored in the non-transitory computer-readable medium and including executable instructions configured to group the plurality of customers, as represented by at least counts of the plurality of customers, into a first group and a second group by applying a clustering algorithm to the sales data;
a distribution module stored in the non-transitory computer-readable medium and including executable instructions configured to generate a corresponding pair of vector data structures for each demographic attribute of the plurality of demographic attributes; and
a priority module stored in the non-transitory computer-readable medium and including executable instructions configured to generate a plurality of priority values by calculating a normalized distance measure between each corresponding pair of vector data structures corresponding to a same demographic attribute of the plurality of demographic attributes;

12. The computing system of claim 11, further comprising a binning module, including instructions stored in the non-transitory computer-readable medium, configured to:
for each demographic attribute of the plurality of demographic attributes:
determine a plurality of bins across which counts of the first group of customers and counts of the second group of customers associated with the demographic attribute data are to be distributed and normalized, wherein the plurality of bins are derived from the demographic attribute data from each of the plurality of customers.
wherein the distribution module is configured to:
distribute and normalize the counts of the first group of customers across the plurality of bins in a first data structure as part of generating the corresponding pair of vector data structures, and
distribute and normalize the counts of the second group of customers across the plurality of bins in a second data structure as part of generating the corresponding pair of vector data structures.

13. The computing system of claim 11, further comprising a database device configured to store at least the demographic attribute data and the sales data.

14. The computing system of claim 11, further comprising a ranking and selection module, including instructions stored in the non-transitory computer-readable medium, configured to:
rank the plurality of priority values by numerically ordering the plurality of priority values;
selecting a subset of the plurality of demographic attributes corresponding to highest ranked priority values of the plurality of priority values; and
identify the demographic attribute data corresponding to the subset, as selected, as an input into an external segmentation tool to segment the counts of the plurality of customers.

15. The computing system of claim 14, wherein the ranking and selection module is configured to generate and transmit a computerized control message, via network communications, to direct the external segmentation tool to perform a segmentation of the counts of the plurality of customers by applying the external segmentation tool to the demographic attribute data corresponding to the subset of the plurality of demographic attributes.

16. The computing system of claim 11, wherein the visual user interface module is configured to provide a graphical user interface.

17. The computing system of claim 16, further comprising a display screen configured to display and facilitate user interaction with at least the graphical user interface.

18. A non-transitory computer-readable medium storing computer-executable instructions that, when executed by a computer, cause the computer to perform functions, wherein the instructions comprise:
instructions for retrieving at least one computerized data structure having sales data representing a target attribute for each customer of a plurality of customers and demographic attribute data representing a plurality of demographic attributes for each customer of the plurality of customers;
instructions for grouping the plurality of customers, as represented by at least counts of the plurality of customers, into a first group and a second group by applying a clustering algorithm to the sales data;
instructions for generating a corresponding pair of vector data structures for each demographic attribute of the plurality of demographic attributes;
instructions for generating a plurality of priority values by calculating a normalized distance measure between each corresponding pair of vector data structures corresponding to a same demographic attribute of the plurality of demographic attributes; and
instructions for controlling a segmentation of the counts of the plurality of customers by generating and transmitting a computerized control message, via network communications, to an external segmentation tool to cause the external segmentation tool to be applied to, based on the plurality of priority values, the demographic attribute data associated with at least one demographic attribute of the plurality of demographic attributes.

19. The non-transitory computer-readable medium of claim 18, wherein the instructions further include:
instructions for determining a plurality of bins across which counts of the first group of customers and counts of the second group of customers associated with the demographic attribute data are to be distributed and normalized, wherein the plurality of bins are derived from the demographic attribute data from each of the plurality of customers,
wherein the instructions for generating a corresponding pair of vector data structures include:
instructions for distributing and normalizing the counts of the first group of customers across the plurality of bins in a first data structure, and
instructions for distributing and normalizing the counts of the second group of customers across the plurality of bins in a second data structure.

20. The non-transitory computer-readable medium of claim 18, wherein the instructions further include:
instructions for ranking the plurality of priority values by numerically ordering the plurality of priority values;
instructions for selecting the at least one demographic attribute corresponding to at least a highest ranked priority value of the plurality of priority values; and
instructions for identifying the demographic attribute data corresponding to the at least one demographic attribute, as selected, as an input into the external segmentation tool to segment the counts of the plurality of customers.
